(19) United States
(12) Patent Application Publication
(10) Pub. No.: US 2014/0076230 A1
(43) Pub. Date: Mar. 20, 2014

(54) PRESSURE GAUGE FOR POSSIBLE USE IN AN AIRCRAFT

(71) Applicant: AVOX SYSTEMS, INC., Lancaster, NY (US)

(72) Inventors: Raymond Jones, Cheektowaga, NY (US); Frank Dorogi, Buffalo, NY (US)

(73) Assignee: AVOX SYSTEMS, INC., Lancaster, NY (US)

(21) Appl. No.: 14/028,637

(22) Filed: Sep. 17, 2013

Related U.S. Application Data
(60) Provisional application No. 61/701,855, filed on Sep. 17, 2012.

(51) Int. Cl. G01D 13/02; G01D 13/22

(52) U.S. Cl. CPC G01D 13/02; G01D 13/22
USPC 116/300

(57) ABSTRACT

A pressure gauge for possible use in an aircraft. The pressure gauge includes a pointer and at least a first set of indicators and a second set of indicators that indicate an amount of pressure being applied to the gauge. The first set of indicators may be positioned along a front surface of the gauge and the second set of indicators may be positioned along a side surface of the gauge that is generally orthogonal to the front surface. The pointer includes a body that extends in a first direction that is contained in a first plane and a distal tip that extends in a second direction that is contained in a second plane that is generally orthogonal to the first plane.

### CROSS-REFERENCE TO RELATED APPLICATIONS

This application claims the benefit of U.S. Provisional Application Ser. No. 61/701,855 filed Sep. 17, 2012 and titled “Pressure Gage with Two Pressure Indication Features,” the contents of which are incorporated herein by reference.

### FIELD OF THE INVENTION

Embodiments of the invention generally relate to pressure gauges.

### BACKGROUND OF THE INVENTION

Pressure cylinders are used to distribute gas or fluids stored at a pressure that is different from ambient pressure. Pressure vessels are used in a variety of applications and industries, including but not limited to the storage of breathing oxygen in aircrafts. A pressure gauge attached to the pressure cylinder measures the pressure of the gas or liquid contained within the cylinder.

One example of a standard pressure gauge is a Bourdon pressure gauge, which includes a tube or coil that tends to expand in cross section when pressurized. As the pressure increases, the closed end of the tube/coil rotates, which rotates a pointer that aligns with an indicator that indicates the pressure of the gas or liquid contained within the cylinder. Traditionally, the gauge includes one indicator along the front face of the gauge.

### SUMMARY OF THE INVENTION

The terms “invention,” “the invention,” “this invention” and “the present invention” used in this patent are intended to refer broadly to all of the subject matter of this patent and the patent claims below. Statements containing these terms should not be understood to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to the entire specification of this patent, all drawings and each claim.

In certain embodiments there is provided a pressure gauge with more than one pressure indication feature such that the pressure measurement is visible when viewed from different angles, such as but not limited to a front view and a side view generally orthogonal to the front view. In some embodiments, the pressure gauge includes a first set of pressure indicators along a front surface of the gauge and a second set of pressure indicators along a side surface that is generally orthogonal to the front surface.

### BRIEF DESCRIPTION OF THE DRAWINGS

A full and enabling disclosure including the best mode of practicing the appended claims and directed to one of ordinary skill in the art is set forth more particularly in the remainder of the specification. The specification makes reference to the following appended figures, in which use of like reference numerals in different features is intended to illustrate like or analogous components.

FIG. 1 is a side perspective view of a pressure gauge according to one embodiment.

FIG. 2 is an exploded view of the pressure gauge of FIG. 1.

FIG. 3 is a front plan view of the pressure gauge of FIG. 1, shown assembled with a pressure cylinder.

FIG. 4 is a side perspective view of the pressure gauge of FIG. 1, shown assembled with a pressure cylinder.

### DETAILED DESCRIPTION OF THE DRAWINGS

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

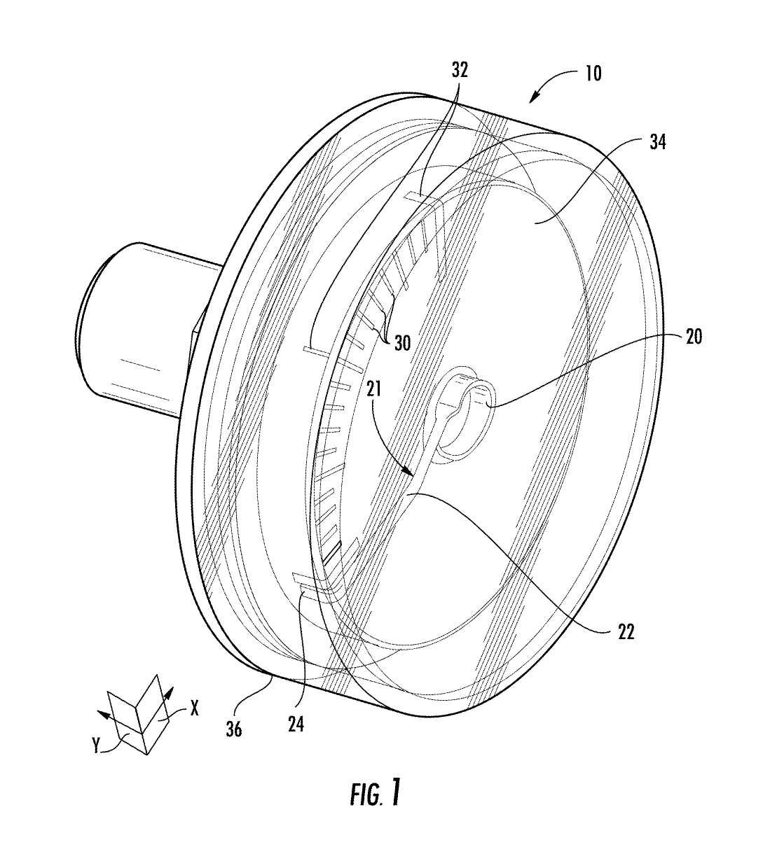

Disclosed herein are pressure gauges for use with pressure cylinders and the like, including but not limited to portable oxygen cylinders used in aircraft or other suitable applications. As shown in FIG. 1, pressure gauge 10 includes a pointer 21 having a body 22 that extends in a first direction and that bends at a distal tip 24 in a second direction that is generally perpendicular to the first direction. The first direction is contained within plane X (FIG. 1) and the second direction is contained within plane Y (FIG. 1), which is generally orthogonal to plane X.

A first set of pressure indicators 30 is included along the front face 34 of the gauge 10. The first set of pressure indicators 30 is generally contained within the same plane X as body 22. A second set of pressure indicators 32 is included along the side 36 of the gauge and is generally contained within the same plane Y as the distal tip 24. In this way, the pressure measurement indicated by pointer 21 can be viewed from both the front of the gauge 10 and the side 36 of the gauge 10.

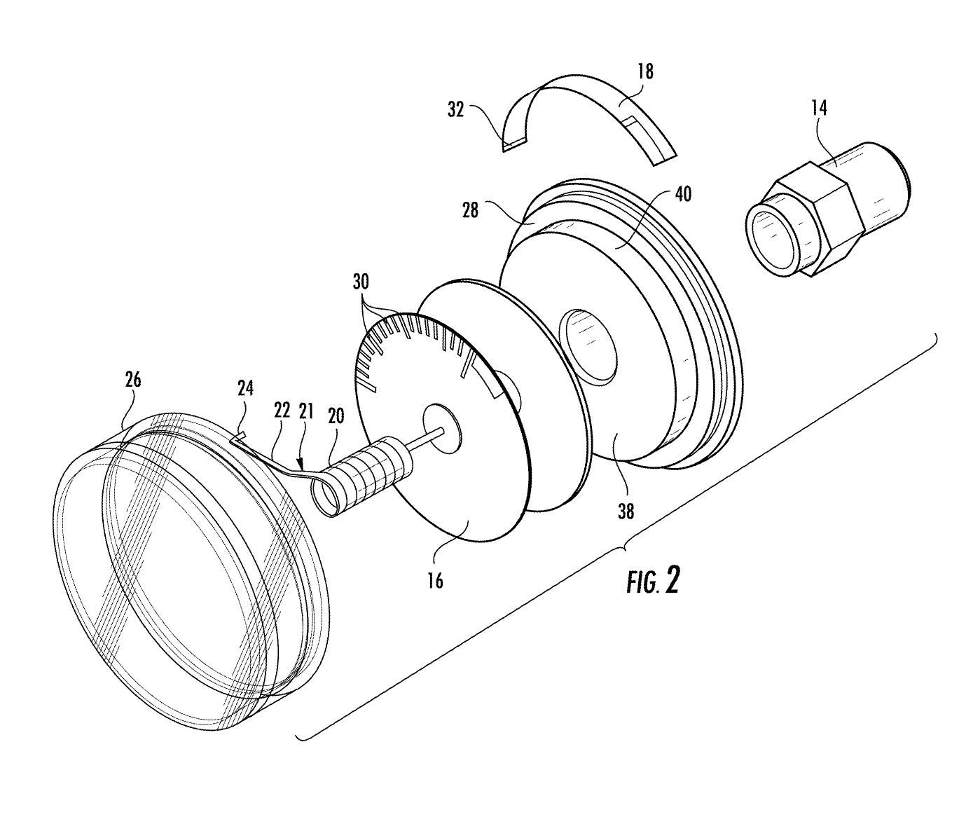

As shown in FIG. 2, pointer 21 extends from a coil 20 that is configured to expand when pressurized. As it expands, pointer 21 rotates so that it corresponds to the suitable indicator that identifies the pressure being applied to coil 20. In particular, body 22 corresponds to the suitable indicator from the first set of pressure indicators 30 and distal tip 24 corresponds to the suitable indicator from the second set of pressure indicators 32. Since distal tip 24 extends approximately orthogonally from the body 22 of pointer 21, the body 22 of pointer 21 points to the appropriate indicator 30 along the front surface 38 of case 28, while the distal tip 24 of pointer 21 points to the appropriate indicator 32 along the side surface 40 of the case 28. Side surface 40 is generally contained within plane Y and is generally orthogonal to front surface 38, which is generally contained within plane X. In this way, the pressure measurement can be read by looking at the face of the gauge, as well as by looking at the side of the gauge. This eliminates constraints on where pressure cylinders can be stored and used.

Indicators, such as indicators 30 and 32, may be printed on or adhered directly to case 28, or may be included on a first dial 16 and a second dial 18 respectively that are then adhered or otherwise attached to case 28. If used, second dial 18 is configured to be positioned along the side surface 40 of the case 28, while first dial 16 is configured to be positioned along the front surface 38 of the case 28. In some embodiments, first dial and second dial are separate components, while in other embodiments they are one piece.

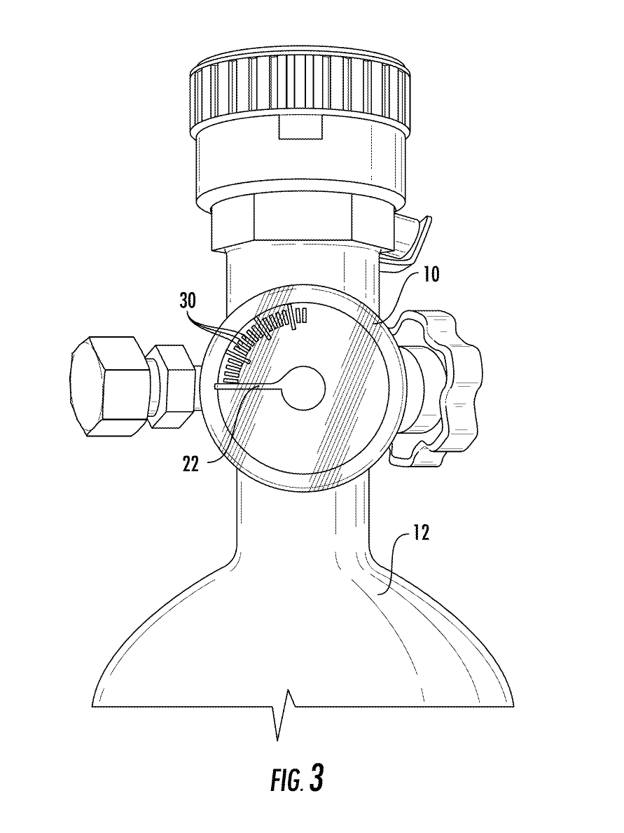

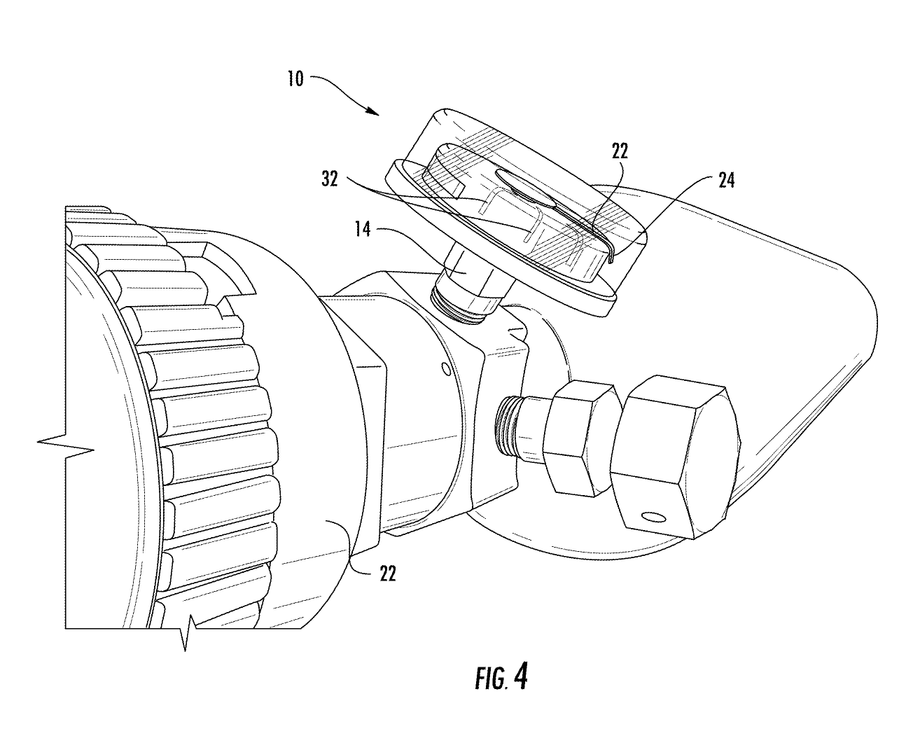

As shown in FIG. 2, gauge 10 may include a fitting 14 for attaching the gauge to a pressure cylinder, such as pressure cylinder 12 shown in FIGS. 3-4, by threading or otherwise. The pressure gauge 10 may also include a cover 26 that protects the internal parts of the gauge, including the coil 20, the pointer 21, and the first and second sets of pressure indicators 30, 32, and prevents access to and/or tampering with the components of the gauge.

The foregoing is provided for purposes of illustrating, explaining, and describing embodiments of the present invention. Further modifications and adaptations to these embodiments will be apparent to those skilled in the art and may be made without departing from the scope or spirit of the invention. Different arrangements of the components depicted in the drawings or described above, as well as components and steps not shown or described are possible. Similarly, some features and subcombinations are useful and may be employed without reference to other features and subcombinations.

Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below. For example, although the various planes, surfaces, and directions referred to herein are described as generally orthogonal to one another, they are not so limited and may be oriented at any suitable angle relative to one another. Similarly, the distal tip may extend from the body of the pointer at any suitable angle.

Moreover, although pressure gauge 10 is illustrated as a Bourdon type pressure gauge, any suitable type of pressure gauge that has a needle/pointer may include the at least two sets of pressure indicators described herein. Moreover, in some embodiments, the pressure gauge includes more than two sets of indicators. Pressure gauge 10 is also not limited to use with pressure cylinders, but may be used in any suitable application where it is desirable to measure pressure and to read such measurements from various angles relative to the gauge.

We claim:

1. A pressure gauge for use in an aircraft, the gauge comprising:
a case comprising a front surface and a side surface that is generally orthogonal to the front surface;
a first set of pressure indicators along the front surface;
a second set of pressure indicators along the side surface;
a pointer comprising a body and a distal tip, wherein the body extends in a first direction contained within a first plane and wherein the distal tip extends in a second direction contained within a second plane that is generally orthogonal to the first plane, and
wherein the body of the pointer is configured to align with the first set of pressure indicators and wherein the distal tip of the pointer is configured to align with the second set of pressure indicators.

2. The pressure gauge of claim 1, further comprising:
a first dial that includes the first set of pressure indicators and that is affixed to the front surface; and
a second dial that includes the second set of pressure indicators and that is configured to extend around at least a portion of the side surface.

3. The pressure gauge of claim 1, further comprising a cover that protects the pointer and the first and second sets of pressure indicators.

4. The pressure gauge of claim 1, wherein the pointer extends from a coil that expands and rotates when pressurized.

5. The pressure gauge of claim 1, further comprising a fitting that attaches the pressure gauge to a pressure cylinder of the aircraft.

6. The pressure gauge of claim 1, wherein the pressure gauge is a Bourdon type pressure gauge.

7. A pressure gauge comprising:
a first set of pressure indicators positioned along a front surface of the pressure gauge, wherein the first set of pressure indicators indicates a measurement of pressure passing through the pressure gauge;
a second set of pressure indicators positioned along a side surface that is generally orthogonal to the front surface, wherein the second set of pressure indicators indicates the measurement of pressure passing through the pressure gauge.

8. The pressure gauge of claim 7, further comprising a pointer having a body and a distal tip,
wherein the body of the pointer is contained within a first plane and aligns with the first set of pressure indicators, the first set of pressure indicators being contained within the first plane, and
wherein a distal tip of the pointer is contained within a second plane that is generally orthogonal to the first plane and wherein the distal tip aligns with the second set of pressure indicators, the second set of pressure indicators being contained within the second plane.

9. The pressure gauge of claim 8, wherein the body of the pointer extends in a first direction and wherein the distal tip of the pointer extends in a second direction that is generally orthogonal to the first direction.

10. The pressure gauge of claim 7, further comprising a cover that covers the front surface and the side surface.

11. The pressure gauge of claim 7, wherein the pointer extends from a coil that expands and rotates relative to the first and second sets of pressure indicators when pressurized.

12. The pressure gauge of claim 7, further comprising a fitting configured to attach the pressure gauge to a pressure cylinder.

13. The pressure gauge of claim 7, further comprising a fitting configured to attach the pressure gauge to a pressure cylinder of an aircraft.

14. A pressure gauge comprising a pointer comprising a body and a distal tip,
wherein the body extends in a first direction contained within a first plane and the distal tip extends in a second direction contained within a second plane that is generally orthogonal to the first plane, and
wherein the body is configured to align with a first set of pressure indicators to indicate a measurement of pressure passing through the gauge and wherein the distal tip is configured to align with a second set of pressure indicators to indicate the measurement of pressure passing through the gauge.

15. The pressure gauge of claim 14, further comprising a front surface that includes the first set of pressure indicators and a second surface that is generally orthogonal to the first surface and that includes the second set of pressure indicators.

16. The pressure gauge of claim 15, further comprising a cover that covers the front surface and the side surface.

17. The pressure gauge of claim 14, wherein the pointer extends from a coil that expands and rotates relative to the first and second sets of pressure indicators when pressurized.

18. The pressure gauge of claim 14, further comprising a fitting configured to attach the pressure gauge to a pressure cylinder.

19. The pressure gauge of claim 14, further comprising a fitting configured to attach the pressure gauge to a pressure cylinder of an aircraft.
